(19) United States
(12) Patent Application Publication
(10) Pub. No.: US 2026/0023058 A1
(43) Pub. Date: Jan. 22, 2026

(54) Method of Processing Chromatograph Mass Spectrometry Data and Non transitory Tangible Medium

(71) Applicant: SHIMADZU CORPORATION, Kyoto-shi (JP)

(72) Inventor: Satoshi SHIMIZU, Kyoto-shi (JP)

(73) Assignee: SHIMADZU CORPORATION, Kyoto-shi (JP)

(21) Appl. No.: 19/270,651

(22) Filed: Jul. 16, 2025

(30) Foreign Application Priority Data
Jul. 16, 2024 (JP) 2024-113196

(51) Int. Cl. G01N 30/86; G01N 30/72

(52) U.S. Cl. CPC G01N 30/8658; G01N 30/72; G01N 30/8693

(57) ABSTRACT

In the present disclosure, values of a plurality of feature items are extracted from chromatograph mass spectrometry data of a sample. Each of the plurality of feature items corresponds to a combination of a range of retention time and a mass-to-charge ratio. A machine learning model for predicting physical property information from a value of at least one of the plurality of feature items is generated. For each of one or more feature items of the at least one of the plurality of feature items, importance in the machine learning model is identified and output.

### CROSS REFERENCE TO RELATED APPLICATIONS

This nonprovisional application is based on Japanese Patent Application No. 2024-113196 filed on Jul. 16, 2024 with the Japan Patent Office, the entire contents of which are hereby incorporated by reference.

### BACKGROUND OF THE INVENTION

### Field of the Invention

The present invention relates to a method of processing data, and particularly to a method of processing chromatograph mass spectrometry data.

### Description of the Background Art

In order to identify a factor that influences a specific physical property in a material, the result of an analysis on the material is searched for a feature amount. In one example of the search for the feature amount, an operator has identified peaks in chromatograph mass spectrometry data of each of a plurality of samples for a certain material, tabulated the identified peaks along with values of specific physical properties, and then conducted statistical processing and/or machine learning to extract a peak, as a marker, influencing a specific physical property.

Chromatograph mass spectrometry data includes unseparated or minor peaks and complex peaks. Thus, the above-described method including identification of peaks requires the operator to make an extraordinary effort. Under such circumstances, various studies have been conducted on automation of extraction of a marker in chromatograph mass spectrometry data (for example, see “Marker discovery in volatolomics based on systematic alignment of GC-MS signals: Application to food authentication” (pages 58 to 67) by S. Abou-el-karam a, J. Ratel a, N. Kondjoyan a, C. Truan a, b, E. Engel (Oct. 23, 2017; Analytica Chimica Acta; Elsevier, the Netherlands).

### SUMMARY OF THE INVENTION

On the other hand, there is also a case where the operator still desires to identify the feature amount by himself/herself, for example, when it is estimated that a complex relation exists between the analysis result and the physical property. In such a case, however, no study has been made on a technique for assisting the operator to identify the feature amount.

The present disclosure has been made in view of the above-described circumstances, and an object thereof is to provide a technique for assisting an operator who uses chromatograph mass spectrometry data to search for a feature amount influencing a specific physical property.

A method of processing chromatograph mass spectrometry data according to an aspect of the present disclosure is a method of processing chromatograph mass spectrometry data, the method being implemented by a computer. The method includes extracting values of a plurality of feature items from chromatograph mass spectrometry data of a sample. Each of the plurality of feature items corresponds to a combination of a range of retention time and a mass-to-charge ratio, a plurality of the combinations respectively corresponding to the plurality of feature items are different from each other, and the chromatograph mass spectrometry data is associated with physical property information representing a given physical property. The method further includes generating training data for a plurality of the samples. The training data includes the physical property information and at least one of the plurality of feature items for the chromatograph mass spectrometry data of each of the plurality of the samples. The method further includes: generating, with use of the training data, a machine learning model for predicting the physical property information from a value of the at least one of the plurality of feature items; identifying importance in the machine learning model, the importance being importance of each of one or more feature items of the at least one of the plurality of feature items; and outputting the importance of each of the one or more feature items.

A non-transitory tangible medium according to an aspect of the present disclosure has a program stored thereon in a non-transitory manner, and the program, by being executed by one or more processors of a computer, causes the computer to perform the method of processing chromatograph mass spectrometry data.

The foregoing and other objects, features, aspects, and advantages of the present invention will become apparent from the following detailed description of the present invention when taken in conjunction with the accompanying drawings.

### BRIEF DESCRIPTION OF THE DRAWINGS

FIG. 1 is a diagram showing an overall configuration of an analysis system.

FIG. 2 is a diagram showing a specific example of chromatograph mass spectrometry data.

FIG. 3 is a diagram showing a flow of data processing in the present embodiment.

FIG. 4 is a diagram showing peak information of each of two chromatograms.

FIG. 5 is a diagram for illustrating the possibility of correspondence between a reference peak and a target peak.

FIG. 6 is a diagram showing an example of exception matching.

FIG. 7 is a diagram showing a specific example of a plurality of feature items.

FIG. 8 is a diagram showing an example of a screen for displaying importance.

### DESCRIPTION OF THE PREFERRED EMBODIMENTS

Hereinafter, embodiments of the present disclosure will be described in detail with reference to the accompanying drawings. The same or corresponding portions in the drawings are denoted by the same reference characters, and the description thereof will not be repeated.

### [Hardware Configuration]

In the present embodiment, a computer that executes a processing method is configured to be able to communicate with a gas chromatograph mass spectrometer (hereinafter also referred to as “GC/MS”) in an analysis system. Note that the computer need not be configured to communicate with the GC/MS as long as it has a function of processing chromatograph mass spectrometry data.

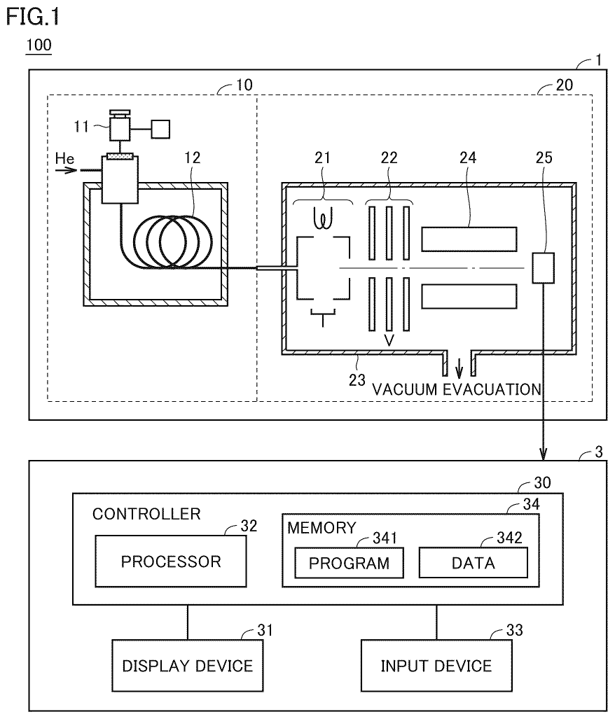

FIG. 1 is a diagram showing an overall configuration of an analysis system. An analysis system 100 includes a GC/MS 1 and a data processing device 3. GC/MS 1 is configured to be able to communicate with data processing device 3. In the present embodiment, data processing device 3 implements a computer that executes the above-mentioned processing method.

GC/MS 1 includes a gas chromatograph 10 and a mass spectrometer 20. Gas chromatograph 10 includes an injector 11 for introducing a sample and a column 12 for separating components of the sample introduced by injector 11. One or more components included in the sample are separated while passing through column 12. The components are sequentially introduced into mass spectrometer 20.

Mass spectrometer 20 includes a vacuum chamber 23 evacuated by a vacuum pump (not shown) into a vacuum state, as well as an ion source 21, a lens electrode 22, a quadrupole mass filter 24, and an ion detector 25 that are disposed inside vacuum chamber 23.

The components having passed through column 12 are sequentially introduced into ion source 21 of mass spectrometer 20 and then ionized. The ionized components are converged by lens electrode 22, separated according to the mass-to-charge ratio (m/z) by quadrupole mass filter 24, and then detected by ion detector 25.

Mass spectrometer 20 is capable of performing a scan measurement. In the scan measurement in mass spectrometer 20, while the mass-to-charge ratio at which the components are passed through quadrupole mass filter 24 is set in a prescribed mass-to-charge ratio range for scanning, ions are detected in each mass-to-charge ratio by ion detector 25. The scan measurement is repeatedly performed at prescribed time intervals. The detection results obtained by ion detector 25 are sequentially transmitted to data processing device 3. Mass spectrum data is obtained at prescribed time intervals, and thereby, time-series data of the mass spectrum (chromatograph mass spectrometry data) is obtained. In the present disclosure, the chromatograph mass spectrometry data is not limited to data acquired as a result of measurement in the GC/MS, but may be data acquired as a result of measurement in a liquid chromatograph mass spectrometer.

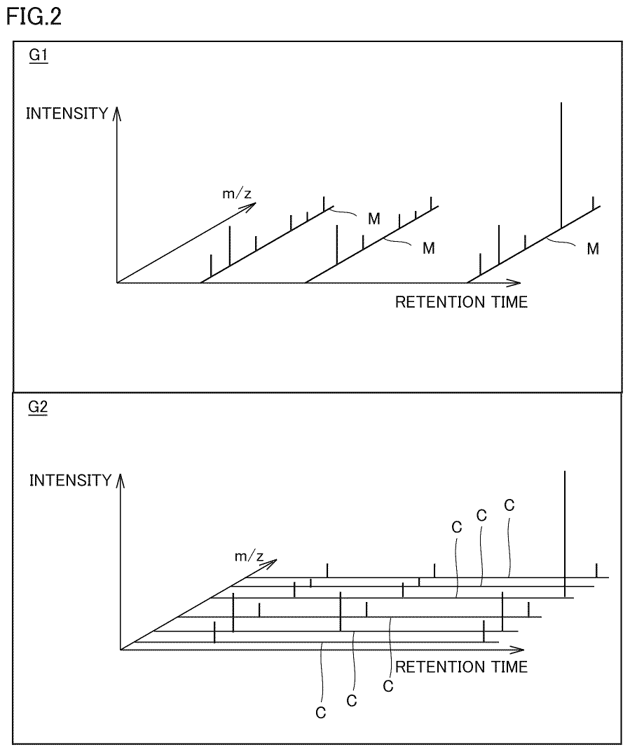

FIG. 2 is a diagram showing a specific example of the chromatograph mass spectrometry data. In the following description, the chromatograph mass spectrometry data is also referred to as “GCMS data”. As shown as graphs G1 and G2 in FIG. 2, the GCMS data has three axes of: intensity (intensity of detected ions), retention time, and m/z. The chromatograph mass spectrometry data includes a plurality of pieces of mass spectrum data M respectively corresponding to different retention times, as shown as graph G1. Note that the chromatograph mass spectrometry data can also be interpreted as a plurality of pieces of chromatogram data C respectively corresponding to different pieces of m/z, as shown as graph G2. In other words, a plurality of pieces of chromatograph data can be identified from the GCMS data.

Referring again to FIG. 1, data processing device 3 includes a controller 30, a display device 31, and an input device 33. Data processing device 3 may have a function of controlling each of parts of GC/MS 1 in addition to a function of processing the chromatograph mass spectrometry data. Note that another device different from data processing device 3 may have the function of controlling each of the parts of GC/MS 1. Data processing device 3 may acquire a detection result (chromatograph mass spectrometry data) obtained by ion detector 25 from a controller having the function of controlling each of the parts of GC/MS 1.

Controller 30 includes a processor 32 and a memory 34. Processor 32 is, for example, a central processing unit (CPU) and is an example of processing circuitry that executes prescribed computing processing described in a program. Processor 32 reads a program and data stored in memory 34, and executes various processes.

Memory 34 includes a non-volatile memory or a volatile memory such as a read only memory (ROM) or a random access memory (RAM), and/or a mass storage device such as a hard disc drive (HDD) or a solid state drive (SSD). Memory 34 stores, in a non-transitory manner, a program 341 to be executed by processor 32 for executing various processes and various pieces of data 342. Data 342 includes a detection result obtained by ion detector 25.

Display device 31 and input device 33 are connected to controller 30. Display device 31 serves as a device that displays a computation result of processor 32, such as a liquid crystal display (LCD) or an organic electro-luminescence (EL) display, for example. Input device 33 serves as a device that receives an input of information by a user's operation, such as a keyboard, a mouse, a pointing device, or a touch panel, for example.

### [Example of Use of Data Processing]

The GCMS data includes values about a plurality of feature items. In data processing, data processing device 3 outputs the information indicating a feature item among the plurality of feature items that is supposed to influence a certain physical property.

More specifically, in the GCMS data of each of the plurality of samples, the value of each of the plurality of feature items is identified as a feature amount.

Then, for each piece of the GCMS data, the set of feature amounts is tagged with the information related to the above-mentioned physical property (the value related to the physical property or the classification related to the physical property). In the following description, the “information related to the physical property” is also referred to as “physical property information”.

Then, a collection of the sets of feature amounts tagged with the pieces of information mentioned above is generated as training data for (the plurality of pieces of GCMS data of) the plurality of samples.

Then, the above-mentioned training data is used to generate a machine learning model for predicting physical property information from the value of at least one of the plurality of feature items. The machine learning model may be a regression model or a classification model.

Then, the importance in the machine learning model is identified for each of one or more feature items of at least one of the feature items.

Then, the importance of each of the one or more feature items is output as an example of the “information indicating a feature item that is supposed to influence a physical property” as mentioned above.

In the above description, one example of the feature item is a combination of a range of the retention time of “9.0 minutes to 9.5 minutes” and (a range) of the value of m/z of “98”. For such a feature item, the value representing a feature of the intensity in a range identified by the above-mentioned combination is identified as a feature amount from the GCMS data. One example of the feature amount is an integrated value of the intensity in the range identified by the feature item. Another example is a maximum value of the intensity in the range identified by the feature item.

### [Process Flow]

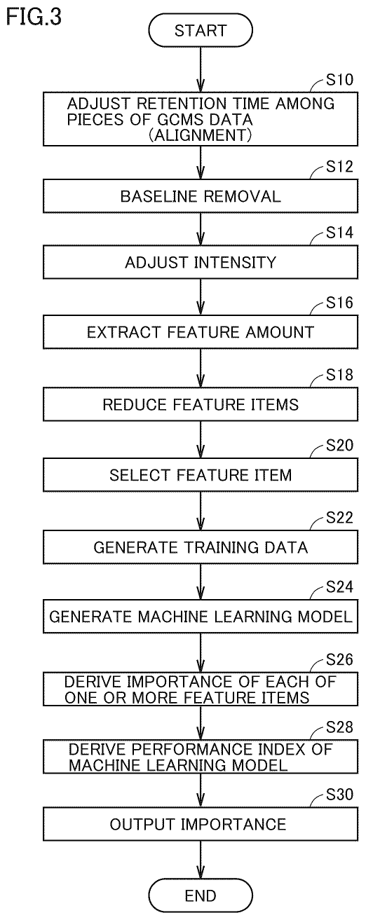

FIG. 3 is a diagram showing a flow of data processing in the present embodiment. In one implementation, in data processing device 3, the process in FIG. 3 is implemented by execution of a given program by processor 32 (a CPU). In one implementation, data processing device 3 starts the process in FIG. 3 in response to an input of an instruction to start the process of the chromatograph mass spectrometry data. The details of the process will be described with reference to FIG. 3.

In step S10, data processing device 3 reads a plurality of pieces of the GCMS data of the plurality of samples, and adjusts the retention time among the plurality of pieces of GCMS data of the plurality of samples.

The adjustment of the retention time is also generally referred to as “alignment”. One example of alignment is described, for example, in a reference “Retention Time Alignment Algorithm of Chromatogram” by Akira Noda; Shimadzu Hyoron, Supplementary Volume, Shimadzu Corporation, Japan (2012, Vol. 69, Nos. 3 and 4, pages 265 to 269).

More specifically, one example of the alignment is an improved version of coarse-to-fine dynamic programming (DP) approach, which is one approach of DP generally used in speech recognition and image processing.

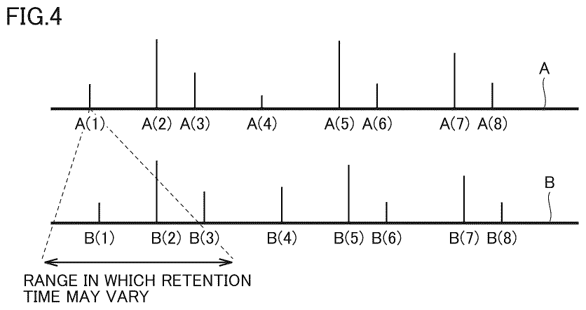

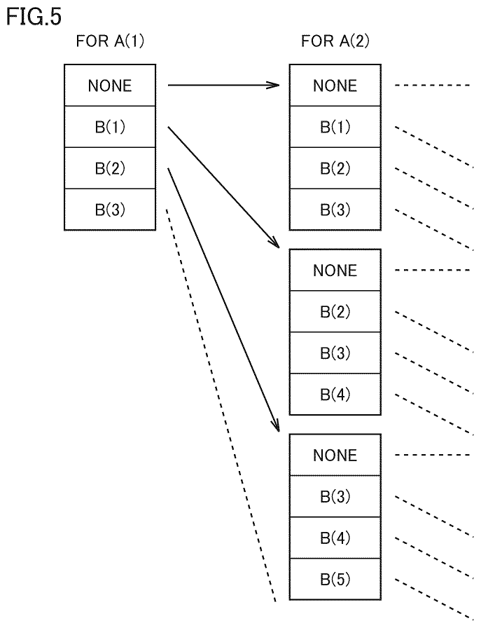

In the “DP” approach, on the assumption that both the retention time and the peak intensity vary, an examination is made to assume as to how the retention time varies for allowing the best matching between the retention time and the peak intensity. The DP procedure will be hereinafter described with reference to FIGS. 4 and 5. FIG. 4 is a diagram showing peak information of each of two chromatograms. FIG. 5 is a diagram for illustrating the possibility of correspondence between a reference peak and a target peak.

The DP procedure includes the following a) to d).

a)

As shown in FIG. 4, chromatograms A and B are assumed. As shown in FIG. 4, by considering the realistic range of the variation in retention time (the “range in which retention time may vary” in FIG. 4), peaks B(1) to B(3) on chromatogram B are selected as peaks to which a peak A(1) on chromatogram A may correspond, or it can be determined that the peak to which peak A(1) on chromatogram A corresponds does not exist on chromatogram B.

b)

For each of four candidates (no corresponding point, B(1), B(2), and B(3)) regarding A(1) obtained in the above-mentioned a), a peak candidate on chromatogram B is identified by considering a realistic range of the variation in retention time in the same manner as in the above-mentioned a).

Thereby, regarding A(2), as shown in FIGS. 5, B(1) to B(3) are obtained as candidates for “no corresponding point”; B(2) to B(4) are obtained as candidates for B(1); B(3) to B(5) are obtained as candidates for B(2); and B(4) to B(6) are obtained as candidates for B(3).

The obtained candidates are combined with “no corresponding point”, and A(2) is associated with each of the four candidates for A(1).

c)

By repeating the above-mentioned a) and b), candidates of about the n-th power of 4 are obtained for n peaks on chromatogram A.

d)

For each candidate, a score is calculated based on the degree of coincidence of intensities and the smoothness of the variation in time, and then, a candidate having the best score for each peak on chromatogram A is selected.

In the above-described example, the number of candidates that can be handled from the range in which the retention time may vary is four each time, and thus, candidates of the n-th power of 4 were obtained for n peaks on chromatogram A. In practice, the number of candidates may vary depending on the peak appearance time pattern. If “m” candidates appear on average, the order of the search range is “mⁿ” on condition that the number of peaks is “n”. Since the search range increases exponentially with respect to the number of peaks, DP that serves to search for all the peaks is impractical.

Then, “coarse-to-fine DP” will be hereafter described.

Normally, in the DP, a beam search is performed in order to narrow the peak search range to a realistic range. In a beam search, only the top hundred candidates are handled at all times, and no search is performed on the combinations of the candidates other than these top hundred candidates. This leads to an advantage that the search ends in a certain calculation time period proportional to the number “n” of peaks. Due to the influence of the beam search, however, the range in which perfect search is enabled is narrowed, and local optima in a narrow time range are to be accumulated. This leads to a side effect that only a few incorrect matchings are sequentially made at an early time, but no matching can be made in the latter half of the search.

In order to address this side effect, DP processing (coarse-to-fine DP) divided into two stages of a coarse stage and a dense stage is used in addition to beam search.

In the coarse stage, the peaks are thinned out to reduce the value of “n” in the order of the search range. This allows accurate alignment to be implemented with respect to rough variations in retention time in a limited beam width.

Peaks with high intensity are regarded as reliable peaks, and only large peaks are used in the coarse stage DP.

The variations in retention time between a plurality of chromatograms are constituted of a large slow variation and a small variation for each peak. Thus, after the coarse stage DP, only a small variation remains between the plurality of chromatograms. Such a small variation is processed in the dense stage DP.

In the dense stage DP, since the variation between the plurality of chromatograms is small, a search range “m” can be set to be small. Thereby, a large number “n” of peaks can be accurately processed even in a small beam range.

By performing the two-stage process as described above, the search range can be narrowed in both of the two stages, so that the side effect that no matching can be made by beam search can be alleviated.

In the implementation of the coarse-to-fine DP, the process is performed on the assumption that the result in the coarse stage is correct without fail in the dense stage for the purpose of efficiently reducing the search range. However, due to the characteristics of its algorithm, the DP for the beam search only allows evaluation of the degree of matching on a unidirectional time axis from the past to the future. Thus, entirely unnatural matching occurs on rare occasion.

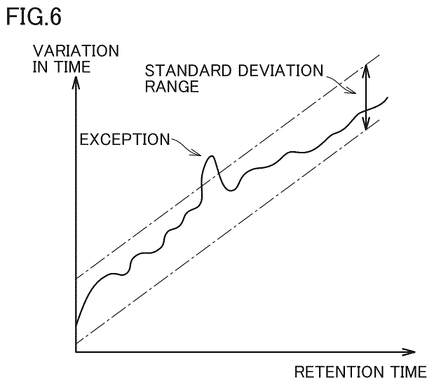

A filtering process may be performed in order to eliminate such exception matching (unnatural matching). FIG. 6 is a diagram showing an example of exception matching. In the determination of exception matching, as shown in FIG. 6, the presence or absence of an extreme deviation is detected by using a local standard deviation of the amount of variation in the intensity per unit time (“variation in time” in FIG. 6).

Referring back to FIG. 3, in step S12 after step S10, data processing device 3 performs baseline removal on the chromatogram data at each m/z. The chromatogram data is identified from the GCMS data of each of the plurality of samples read in step S10. In the baseline removal, a percentile filter may be used. Further, when a blank measurement is periodically performed in the device that has acquired the GCMS data, the baseline removal may be implemented by subtracting the result of the blank measurement.

In step S14, data processing device 3 adjusts the intensity of the GCMS data of each of the plurality of samples read in step S10. When adjusting the intensity, for each piece of the GCMS data, data processing device 3 multiplies the intensities at all the signal points by a uniform coefficient such that the integrated value of the intensities at all the signal points in the two-dimensional matrix of the intensity becomes 1 (or a certain common value).

In step S16, data processing device 3 extracts feature amounts for a plurality of feature items from each piece of the GCMS data.

In one implementation, the plurality of feature items have different ranges identified by retention time of 60-second intervals and at each 1 m/z. For example, in each piece of the GCMS data, when the range of the retention time is 6000 seconds and the range of m/z is 500, then, one hundred types of feature items are identified for the retention time, and five hundred types of feature items are identified for the range of m/z, with the result that there are fifty thousand types of feature items in total. In order to mitigate the “risk that a peak is divided at a certain point thereof” and the “risk that the same peaks in different files belong to different sections due to a retention time deviation”, in adjoining feature items, each of both ends of the retention time in one feature item may overlap, for example, for about 6 seconds, with one end of the retention time in each of the feature items adjacent to this one feature item on both sides. In other words, the feature item having both ends adjacent to other feature items may have a retention time range of 72 seconds (6+60+6). The feature item in which only one end thereof is adjacent to another feature item may have a retention time range of 66 seconds (6+60 or 60+6).

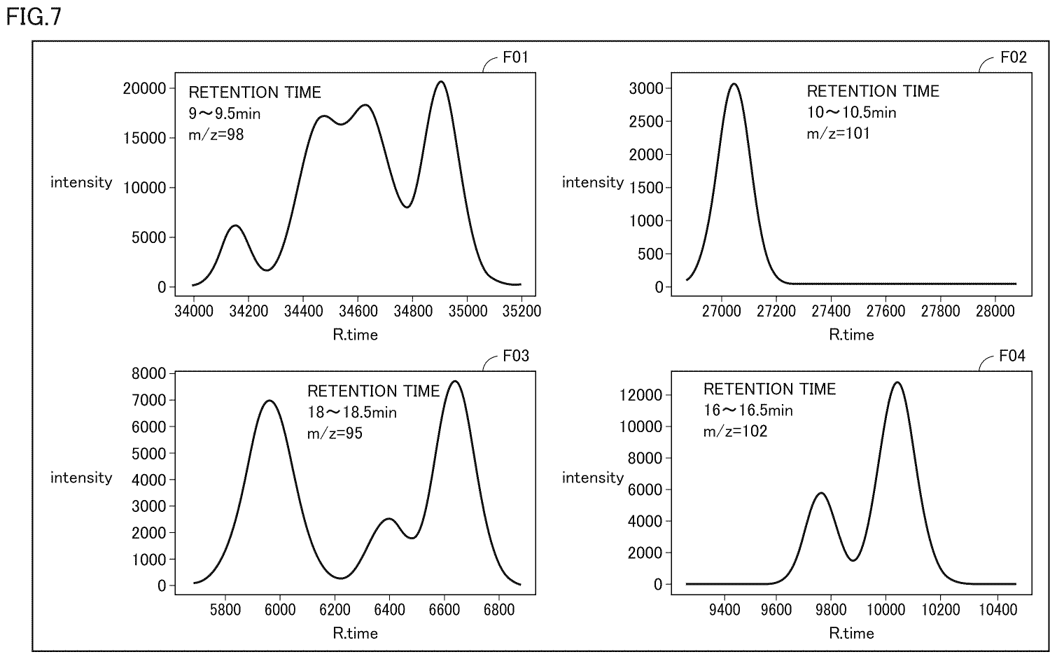

FIG. 7 is a diagram showing a specific example of a plurality of feature items. FIG. 7 shows four types of feature items as fields F01 to F04. Field F01 shows a combination of retention time of 9.0 minutes to 9.5 minutes and m/z=98 as a feature item. Field F02 shows a combination of retention time of 10.0 minutes to 10.5 minutes and m/z=101 as a feature item. Field F03 shows a combination of retention time of 18.0 minutes to 18.5 minutes and m/z=95 as a feature item. Field F04 shows a combination of retention time of 16.0 minutes to 16.5 minutes and m/z=102 as a feature item.

Each of fields F01 to F04 shows chromatogram data corresponding to a feature item extracted from certain GCMS data. In each chromatogram data, the vertical axis represents intensity and the horizontal axis represents retention time. The feature amount of each feature item can be derived using the chromatogram data.

In step S18, data processing device 3 performs a process of reducing the number of feature items used for generating a machine learning model (described later) from the “plurality of feature items” in step S16. In one implementation, any feature item that meets a given condition is excluded in the generation of a machine learning model. In one example of the process for reducing the number of feature items, the value (feature amount) of each feature item is used. More specifically, for each feature item, the maximum value of the feature amounts of the plurality of pieces of GCMS data is identified. Then, the feature item whose maximum value is equal to or smaller than a given threshold value is excluded from the target of the machine learning model. Note that the feature amount of the feature item to be excluded may be assumed to be noise.

In another implementation, the group of the feature items that meet a given condition is treated as a single feature item, with the result that the number of feature items used for generating a machine learning model is reduced. More specifically, data processing device 3 makes a cluster of the feature amounts of the feature items having a common retention time based on the distance function as a correlation coefficient. Thereby, a cluster of the feature items is produced. Data processing device 3 treats this cluster as a new feature item. The feature amount of the new feature item is identified by merging (summing or integrating) the feature amounts of the original feature items.

In step S20, data processing device 3 selects a feature item to be used for generating a machine learning model (described later). In the process in FIG. 3, step S18 may be omitted. In the case where step S18 is omitted, in step S20, a feature item to be used for generating a machine learning model is selected from the “plurality of feature items” in step S16. In the case where step S18 is performed, in step S20, a feature item to be used for generating a machine learning model is selected from the feature items identified to be used for generating a machine learning model after the reduction in number in step S18 (i.e., from at least one of the plurality of feature items).

In step S20, data processing device 3 uses the existing machine learning-based feature amount selection method to remove a feature item not influencing the target physical property, to thereby select a feature item. Examples of the method used in this case may be RandomForest-based Boruta, PLS-based Boruta, or recursive feature elimination (RFE).

In step S22, data processing device 3 generates training data for the machine learning model. The training data includes data about a plurality of samples. The training data is generated by tagging a set of values of the feature items with a physical property value for the GCMS data of each of the plurality of samples. The physical property value may be a numerical value (viscosity, a glass transition temperature, and the like) or may show a classification ((the patient corresponding to a sample) having cancer/not having cancer, and the like).

In step S24, data processing device 3 generates a machine learning model by using the training data generated in step S22. An existing machine learning method (partial least squares (PLS) regression, RandomForest, and the like) may be used for generating a machine learning model. The machine learning model to be generated receives an input of the values of the feature items constituting the training data, to thereby derive a prediction result of the physical property value.

In step S26, data processing device 3 derives the importance of each of one or more feature items in the generated machine learning model. The importance of each feature item may be a VIP of the PLS or the feature importance of RandomForest.

For example, it is assumed that the following equation (1) is identified as a machine learning model.

$$y = a \cdot x 1 + b \cdot x 2 + c \cdot x 3 \qquad ( 1 )$$

In the equation (1), “y” represents an explanatory function (a prediction result), “x1”, “x2”, and “x3” represent values of the feature items, and “a”, “b”, and “c” represent coefficients of “x1”, “x2”, and “x3”, respectively.

In the case of the equation (1), the importance of each of “x1”, “x2”, and “x3” is identified as each of respective coefficients (i.e., “a”, “b”, and “c”).

In step S28, data processing device 3 derives the performance index of the generated machine learning model. In one implementation, data processing device 3 utilizes the generated machine learning model and applies the values of one or more feature items not included in the training data to this machine learning model to thereby acquire a prediction result of the physical property value, and then, derives the performance index by using the prediction result and the actual physical property value. When the machine learning model is a regression model, the performance index may be a coefficient of determination. When the machine learning model is a classification model, the performance index may be an F value.

In step S30, data processing device 3 outputs the importance derived in step S26. The output may be display on display device 31 or may be transmission to an external device. Then, data processing device 3 ends the process in FIG. 3. In step S30, the performance index derived in step S28 may be further output.

In the present embodiment described above, the machine learning model is generated, the importance of each of the one or more feature items in the machine learning model is identified, and each importance is output. Note that the machine learning model may be generated for each of two or more materials. For generating a machine learning model of a certain material, training data generated from each of the plurality of samples of this material may be used.

### [Output Example of Importance]

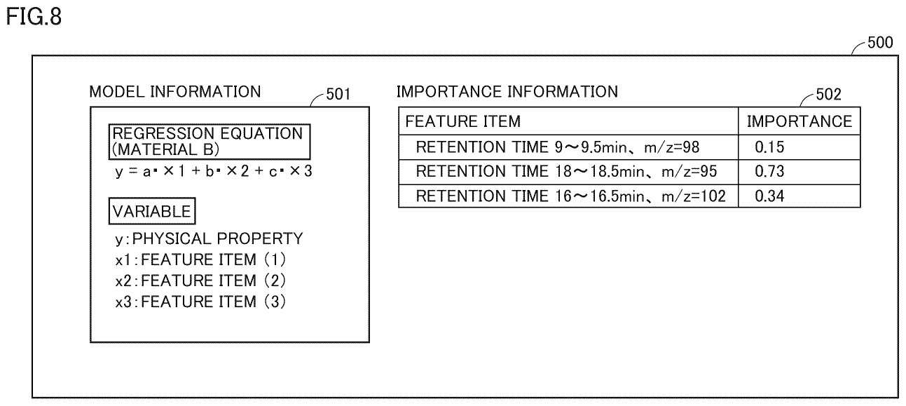

FIG. 8 is a diagram showing an example of a screen for displaying importance. In one implementation, data processing device 3 causes a screen 500 in FIG. 8 to display the importance output in the above-mentioned step S30.

Screen 500 includes display fields 501 and 502. Display field 501 includes information related to the generated machine learning model. In the example in FIG. 8, display field 501 shows a regression equation representing a machine learning model and a description of a variable in this regression equation.

In the example in FIG. 8, display field 501 is targeted for the same machine learning model as that described as the above-mentioned equation (1). In other words, “y” represents an explanatory function (a prediction result), “x1”, “x2”, and “x3” represent values of the feature items, and “a”, “b”, and “c” represent respective coefficients of “x1”, “x2”, and “x3”.

The information shown as an explanation (“physical property”) of a variable “y” in display field 501 corresponds to the prediction result of the machine learning model. For example, when the value of the “viscosity” is derived as a prediction result, the “viscosity” is displayed as a “physical property”. When the classification of “having cancer” or “not having cancer” is derived as a prediction result, “having cancer” is displayed as a “physical property”.

The information displayed as an explanation of each of variables “x1”, “x2”, and “x3” in display field 501 is shown as the details (a combination of the range of the retention time and the value of m/z) of each of the feature items respectively corresponding to variables “x1”, “x2”, and “x3” in the machine learning model. In other words, the actual screen shows a specific combination of the range of the retention time and the value of m/z as each of a “feature item (1)”, a “feature item (2)”, and a “feature item (3)” in FIG. 8.

Display field 502 shows the importance of each feature item in display field 501.

In the example in FIG. 8, the coefficient of each feature item in the machine learning model is shown as the importance of each feature item. For example, a mathematical equation represented in the following equation (2) is generated as a machine learning model of a material B.

$$y = 5.43 \cdot x 1 + 0.32 \cdot x 2 + 5.43 \cdot x 3 \qquad ( 2 )$$

In the equation (2), the coefficient of the feature item (1) represented by “x1” is “5.43”. Thus, display field 502 displays “5.43” as the importance of the feature item (1). Further, since the coefficient of the feature item (2) represented by “x2” is “0.32”, “0.32” is displayed as the importance. Since the coefficient of the feature item (3) represented by “x3” is “5.43”, “5.43” is displayed as the importance.

In the present embodiment described above, the importance of the feature item that is supposed to influence a physical property is displayed for each material, and thereby, the operator can check, without taking time and effort, whether or not it is worthwhile spending the cost for searching for the feature item influencing the target physical property in each material. In this checking process, the operator may also refer to the performance index of the machine learning model.

In the present embodiment, by using a machine learning model, a feature item that is supposed to influence the physical property is derived without requiring the operator to make a fine (difficult in a sense) adjustment of parameters. Further, the feature item can be derived objectively by a machine learning model that robustly operates.

Note that the operator can use the feature item and its importance (and the performance index of the machine learning model) output in the present embodiment as information for primary screening. After checking whether or not it is worthwhile spending the cost, the operator performs a costly secondary screening process (improvement in separation by changing a method, careful and time-consuming peak detection and identification, and the like) on the obtained feature item candidate to thereby finally identify the feature item that influences the physical property.

In the present embodiment, when generating a machine learning model, data is corrected as described in steps S10 to S14, with the result that the influence caused by the variations in retention time and intensity due to the long-term measurement can be alleviated in data analysis.

In the present embodiment, regarding the extraction of the feature amount in step S16, the feature item has a range of the retention time instead of single retention time, so that a robust analysis can be done even when the retention time deviation between the pieces of GCMS data cannot be corrected.

In the present embodiment, in the process of reducing the number of feature items in step S18, the values of the feature items in a physicochemically meaningful group (=mass spectra derived from the same component) are merged and used for generating a machine learning model, so that the multicollinearity of the explanatory variables can be reduced.

### [Aspects]

It will be understood by those skilled in the art that the above-described exemplary embodiments are illustrative examples of the following aspects.

(Clause 1) A method of processing chromatograph mass spectrometry data according to one aspect is a method of processing chromatograph mass spectrometry data, the method being implemented by a computer, the method comprising: extracting values of a plurality of feature items from chromatograph mass spectrometry data of a sample, each of the plurality of feature items corresponding to a combination of a range of retention time and a mass-to-charge ratio, a plurality of the combinations respectively corresponding to the plurality of feature items being different from each other, and the chromatograph mass spectrometry data being associated with physical property information representing a given physical property; generating training data for a plurality of the samples, the training data including the physical property information and at least one of the plurality of feature items for the chromatograph mass spectrometry data of each of the plurality of the samples; generating, with use of the training data, a machine learning model for predicting the physical property information from a value of the at least one of the plurality of feature items; identifying importance in the machine learning model, the importance being importance of each of one or more feature items of the at least one of the plurality of feature items; and outputting the importance of each of the one or more feature items.

According to the method of processing chromatograph mass spectrometry data described in Clause 1, there is provided a technique for assisting an operator who uses the chromatograph mass spectrometry data to search for a feature amount influencing a specific physical property.

(Clause 2) In the method of processing chromatograph mass spectrometry data according to Clause 1, the plurality of the combinations may partially overlap with each other in terms of the range of the retention time.

According to the method of processing chromatograph mass spectrometry data described in Clause 2, it is possible to avoid a situation in which a characteristic change such as a peak is separated by an adjacent feature item and thus cannot be detected in a range defined in a single feature item.

(Clause 3) In the method of processing chromatograph mass spectrometry data according to Clause 1 or 2, the at least one of the plurality of feature items may be smaller in number than the plurality of feature items, and the method may further comprise identifying the at least one of the plurality of feature items by removing a feature item having a value smaller than a given threshold value from the plurality of feature items.

According to the method of processing chromatograph mass spectrometry data described in Clause 3, the number of feature items to be used for generating a machine learning model can be reduced as appropriate.

(Clause 4) In the method of processing chromatograph mass spectrometry data according to any one of Clauses 1 to 3, the at least one of the plurality of feature items may be smaller in number than the plurality of feature items, and the method may further comprise identifying the at least one of the plurality of feature items by integrating two or more feature items among the plurality of feature items into one feature item.

According to the method of processing chromatograph mass spectrometry data described in Clause 4, the number of feature items to be used for generating a machine learning model can be reduced as appropriate.

(Clause 5) The method of processing chromatograph mass spectrometry data according to any one of Clauses 1 to 4 may further comprise selecting the at least one of the plurality of feature items by removing a feature item not influencing the given physical property from the plurality of feature items.

According to the method of processing chromatograph mass spectrometry data described in Clause 5, the number of feature items to be used for generating a machine learning model can be reduced as appropriate.

(Clause 6) In the method of processing chromatograph mass spectrometry data according to any one of Clauses 1 to 5, the machine learning model may be represented by a linear equation, and a coefficient of each of the one or more feature items in the linear equation may be identified as the importance.

According to the method of processing chromatograph mass spectrometry data described in Clause 6, the ground for identifying the importance is clarified.

(Clause 7) A non-transitory tangible medium according to one aspect may have a program stored thereon in a non-transitory manner, the program, by being executed by one or more processors of a computer, causing the computer to perform the method of processing chromatograph mass spectrometry data according to any one of Clauses 1 to 6.

According to the non-transitory tangible medium described in Clause 7, there is provided a technique for assisting an operator who uses the chromatograph mass spectrometry data to search for a feature amount influencing a specific physical property.

Although the embodiments of the present invention have been described, it should be understood that the embodiments disclosed herein are illustrative and non-restrictive in every respect. The scope of the present invention is defined by the terms of the claims, and is intended to include any modifications within the scope and meaning equivalent to the terms of the claims.

What is claimed is:

1. A method of processing chromatograph mass spectrometry data, the method being implemented by a computer, the method comprising:
extracting values of a plurality of feature items from chromatograph mass spectrometry data of a sample, each of the plurality of feature items corresponding to a combination of a range of retention time and a mass-to-charge ratio, a plurality of the combinations respectively corresponding to the plurality of feature items being different from each other, the chromatograph mass spectrometry data being associated with physical property information representing a given physical property;
generating training data for a plurality of the samples, the training data including the physical property information and at least one of the plurality of feature items for the chromatograph mass spectrometry data of each of the plurality of the samples;
generating, with use of the training data, a machine learning model for predicting the physical property information from a value of the at least one of the plurality of feature items;
identifying importance in the machine learning model, the importance being importance of each of one or more feature items of the at least one of the plurality of feature items; and
outputting the importance of each of the one or more feature items.

2. The method of processing chromatograph mass spectrometry data according to claim 1, wherein the plurality of the combinations partially overlap with each other in terms of the range of the retention time.

3. The method of processing chromatograph mass spectrometry data according to claim 1, wherein
the at least one of the plurality of feature items is smaller in number than the plurality of feature items, and
the method further comprises identifying the at least one of the plurality of feature items by removing a feature item having a value smaller than a given threshold value from the plurality of feature items.

4. The method of processing chromatograph mass spectrometry data according to claim 1, wherein
the at least one of the plurality of feature items is smaller in number than the plurality of feature items, and
the method further comprises identifying the at least one of the plurality of feature items by integrating two or more feature items among the plurality of feature items into one feature item.

5. The method of processing chromatograph mass spectrometry data according to claim 1, further comprising selecting the at least one of the plurality of feature items by removing a feature item not influencing the given physical property from the plurality of feature items.

6. The method of processing chromatograph mass spectrometry data according to claim 1, wherein
the machine learning model is represented by a linear equation, and
a coefficient of each of the one or more feature items in the linear equation is identified as the importance.

7. A non-transitory tangible medium having a program stored thereon in a non-transitory manner, the program, by being executed by one or more processors of a computer, causing the computer to perform the method of processing chromatograph mass spectrometry data according to claim 1.
